(19) United States
(12) Patent Application Publication
(10) Pub. No.: US 2026/0156530 A1
(43) Pub. Date: Jun. 4, 2026

(54) TRANSMISSION CONFIGURATION METHOD, APPARATUS, DEVICE, AND STORAGE MEDIUM

(71) Applicant: Beijing Xiaomi Mobile Software Co., Ltd., Beijing (CN)

(72) Inventor: Yanhua LI, Beijing (CN)

(21) Appl. No.: 19/120,923

(22) PCT Filed: Oct. 26, 2022
(86) PCT No.: PCT/CN2022/127788

§ 371 Date: Apr. 14, 2025

(51) Int. Cl. H04W 28/086

(52) U.S. Cl. CPC H04W 28/086

(57) ABSTRACT

A method for transmission configuration is executed by a first node device, and includes: sending flow split related configuration information to a second node device, wherein the flow split related configuration information is used by the second node device to process data of a service.

### CROSS REFERENCE

The present application is a U.S. National Stage of International Application No. PCT/CN2022/127788, filed on Oct. 26, 2022, the content of which is incorporated herein by reference in its entirety.

### TECHNICAL FIELD

The present disclosure relates to the field of communication technologies, and in particular to a method and apparatus for transmission configuration, a device and a storage medium.

### BACKGROUND

In some communication services (for example, Extended Reality (XR) services), concepts of multi-flow transmission and multi-flow modeling are introduced. That is, flow split is performed on service data according to importance of the service data. For example, I frame and P frame are for modeling (I frame represents a relatively important frame, and a User Equipment (UE) can decode based on I frame, but usually cannot decode based on P frame alone). Therefore, on a network device side, frame processing mechanisms (for example, scheduling priority) for data of different types of services may be different.

In the related arts, a flow split function is provided by a Packet Data Convergence Protocol (PDCP). For example, a PDCP layer may be associated with one entity and the service data is delivered to this entity, and if the PDCP layer is associated with a plurality of entities, a method for sending the service data to the entities can be determined according to specific scenarios.

### SUMMARY

In a first aspect, embodiments of the present disclosure provide a method for transmission configuration, which is executed by a first node device, and the method includes: sending flow split related configuration information to a second node device, wherein the flow split related configuration information is used by the second node device to process service data.

In a second aspect, embodiments of the present disclosure provide a method for transmission configuration, which is executed by a second node device, and the method includes: receiving flow split related configuration information sent by a first node device; and performing flow split processing on service data according to the flow split related configuration information.

In a third aspect, embodiments of the present disclosure provide a method for transmission configuration, which is executed by a core network device and/or a third node device, and the method includes: determining service related information, wherein the service related information is used by a first node device to determine flow split related configuration information, and the flow split related configuration information is used by a second node device to perform flow split processing on service data.

In a fourth aspect, embodiments of the present disclosure provide a communication device, which has part or all of functions for implementing the first node device in the method according to the first aspect above. For example, the communication device may have functions as described in some or all the embodiments in the present disclosure, or may also have functions to separately implement any of embodiments in the present disclosure. The functions may be implemented by hardware, or may be implemented by executing corresponding software on the hardware. The hardware or the software includes one or more units or modules corresponding to the above functions.

In an embodiment of the present disclosure, a structure of the communication device may include a transceiving module and a processing module, and the processing module is configured to support the communication device to perform corresponding functions in the above method. The transceiving module is configured to support a communication between the communication device and other devices. The communication device may further include a storage module, which is configured to be coupled with the transceiving module and the processing module, and store necessary computer programs and data of the communication device.

As an example, the processing module may be a processor, the transceiving module may be a transceiver or a communication interface, and the storage module may be a memory.

In a fifth aspect, embodiments of the present disclosure provide another communication device, which has part or all of functions for implementing the second node device in the method examples according to the second aspect above. For example, the communication device may have functions as described in some or all the embodiments in the present disclosure, or may also have functions to separately implement any of embodiments in the present disclosure. The functions may be implemented by hardware, or may be implemented by executing corresponding software on the hardware. The hardware or the software includes one or more units or modules corresponding to the above functions.

In an embodiment of the present disclosure, a structure of the communication device may include a transceiving module and a processing module, and the processing module is configured to support the communication device to perform corresponding functions in the above method. The transceiving module is configured to support a communication between the communication device and other devices. The communication device may further include a storage module, which is configured to be coupled with the transceiving module and the processing module, and store necessary computer programs and data of the communication device.

In a sixth aspect, embodiments of the present disclosure provide another communication device, which has part or all of functions for implementing the core network device and/or the third node device in the method examples according to the third aspect above. For example, the communication device may have functions as described in some or all the embodiments in the present disclosure, or may also have functions to separately implement any of embodiments in the present disclosure. The functions may be implemented by hardware, or may be implemented by executing a corresponding software on the hardware. The hardware or the software includes one or more units or modules corresponding to the above functions.

In an embodiment of the present disclosure, a structure of the communication device may include a transceiving module and a processing module, and the processing module is configured to support the communication device to perform corresponding functions in the above method. The transceiving module is configured to support a communication between the communication device and other devices. The communication device may further include a storage module, which is configured to be coupled with the transceiving module and the processing module, and store necessary computer programs and data of the communication device.

In a seventh aspect, embodiments of the present disclosure provide a communication device, which includes a processor which, when invokes a computer program in a memory, executes the method for transmission configuration according to the first aspect above.

In an eighth aspect, embodiments of the present disclosure provide a communication device, which includes a processor which, when invokes a computer program in a memory, executes the method for transmission configuration according to the second aspect above.

In a ninth aspect, embodiments of the present disclosure provide a communication device, which includes a processor which, when invokes a computer program in a memory, executes the method for transmission configuration according to the third aspect above.

In a tenth aspect, embodiments of the present disclosure provide a communication device, including a processor and a memory having a computer program stored thereon. The processor executes the computer program stored in the memory, to cause the communication device to implement the method for transmission configuration according to the first aspect above.

In an eleventh aspect, embodiments of the present disclosure provide a communication device, including a processor and a memory having a computer program stored thereon. The processor executes the computer program stored in the memory, to cause the communication device to implement the method for transmission configuration according to the second aspect above.

In a twelfth aspect, embodiments of the present disclosure provide a communication device, including a processor and a memory having a computer program stored thereon. The processor executes the computer program stored in the memory, to cause the communication device to implement the method for transmission configuration according to the third aspect above.

In a thirteenth aspect, embodiments of the present disclosure provide a communication device, including a processor and an interface circuit. The interface circuit is configured to receive a code instruction and transmit the code instruction to the processor, and the processor is configured to run the code instruction to cause the device to implement the method for transmission configuration according to the first aspect above.

In a fourteenth aspect, embodiments of the present disclosure provide a communication device, including a processor and an interface circuit. The interface circuit is configured to receive a code instruction and transmit the code instruction to the processor, and the processor is configured to run the code instruction to cause the device to implement the method for transmission configuration according to the second aspect above.

In a fifteenth aspect, embodiments of the present disclosure provide a communication device, including a processor and an interface circuit. The interface circuit is configured to receive a code instruction and transmit the code instruction to the processor, and the processor is configured to run the code instruction to cause the device to implement the method for transmission configuration according to the third aspect above.

In a sixteenth aspect, embodiments of the present disclosure provide a communication system, which includes the communication device of the fourth aspect, the communication device of the fifth aspect, and the communication device of the sixth aspect, or the system includes the communication device of the seventh aspect, the communication device of the eighth aspect, and the communication device of the ninth aspect, or the system includes the communication device of the tenth aspect, the communication device of the eleventh aspect, and the communication device of the twelfth aspect, or the system includes the communication device of the thirteenth aspect, the communication device of the fourteenth aspect, and the communication device of the fifteenth aspect.

In a seventeenth aspect, embodiments of the present disclosure provide a computer-readable storage medium for storing instructions used by the above-mentioned first node device, second node device, core network device and/or third node device. The instructions, when executed, cause the node device, the second node device, the core network device and/or the third node device to implement the method for transmission configuration.

In an eighteenth aspect, the present disclosure further provides a computer program product including a computer program which, when run on a computer, causes the computer to implement the method for transmission configuration.

In a nineteenth aspect, the present disclosure provides a chip system, which includes at least one processor and an interface, configured to support a first node device to implement functions involved in the first aspect, for example, determining or processing at least one of data and information involved in the above method.

In an embodiment, the chip system further includes a memory for storing necessary computer programs and data of the first node device. The chip system may consist of chips, or may include chips and other discrete devices.

In a twentieth aspect, the present disclosure provides a chip system, which includes at least one processor and an interface, configured to support a second node device to implement functions involved in the second aspect, for example, determining or processing at least one of data and information involved in the above method.

In an embodiment, the chip system further includes a memory for storing necessary computer programs and data of the second node device. The chip system may consist of chips, or may include chips and other discrete devices.

In a twenty-first aspect, the present disclosure provides a chip system, which includes at least one processor and an interface, configured to support a core network device and/or a third node device to implement functions involved in the third aspect, for example, determining or processing at least one of data and information involved in the above method.

In an embodiment, the chip system further includes a memory for storing necessary computer programs and data of the core network device and/or the third node device. The chip system may consist of chips, or may include chips and other discrete devices.

In a twenty-second aspect, the present disclosure provides a computer program which, when run on a computer, causes the computer to implement the method for transmission configuration.

### BRIEF DESCRIPTION OF THE DRAWINGS

The accompanying drawings of the present disclosure will be described below.

FIG. 1 is a schematic architectural diagram of a communication system provided by an embodiment of the present disclosure;

FIG. 2 is a schematic flowchart of a method for transmission configuration provided by an embodiment of the present disclosure:

FIG. 3 is a schematic flowchart of a method for transmission configuration provided by an embodiment of the present disclosure:

FIG. 4 is a schematic flowchart of a method for transmission configuration provided by an embodiment of the present disclosure:

FIG. 5 is a schematic flowchart of another method for transmission configuration provided by an embodiment of the present disclosure:

FIG. 6 is a schematic flowchart of another method for transmission configuration provided by an embodiment of the present disclosure;

FIG. 7 is a schematic flowchart of yet another method for transmission configuration provided by an embodiment of the present disclosure:

FIG. 8 is a schematic flowchart of still another method for transmission configuration provided by an embodiment of the present disclosure;

FIG. 9 is a schematic flowchart of still another method for transmission configuration provided by an embodiment of the present disclosure;

FIG. 10 is a schematic structural diagram of a communication device provided by an embodiment of the present disclosure;

FIG. 11 is a schematic structural diagram of another communication device provided by an embodiment of the present disclosure; and

FIG. 12 is a schematic structural diagram of a chip provided by an embodiment of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. Implementations set forth in the following description of the embodiments do not represent all implementations consistent with embodiments of the present disclosure. Instead, they are merely examples of apparatuses and methods consistent with some aspects related to the embodiments of the present disclosure as recited in the appended claims.

The terms used in embodiments of the present disclosure are merely for the purpose of describing particular embodiments and are not intended to limit the embodiments of the present disclosure. As used in the embodiments of the present disclosure and the appended claims, the singular forms “a” and “the” are intended to include the plural forms as well, unless the context clearly indicates otherwise. It should also be understood that the term “and/or” as used herein refers to and includes any or all possible combinations of one or more of the associated listed items.

It should be understood that, although the terms first, second, third, etc. may be used in embodiments of the present disclosure to describe various information, such information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein can be interpreted as “upon” or “when” or “in response to determination”.

As described above, in some communication services (for example, Extended Reality (XR) services), concepts of multi-flow transmission and multi-flow modeling are introduced. That is, flow split is performed on service data according to importance of the service data. For example, I frame and P frame are for modeling (I frame represents a relatively important frame, and a User Equipment (UE) can decode based on I frame, but usually cannot decode based on P frame alone). Therefore, on a network device side, frame processing mechanisms (for example, scheduling priority) for data of different types of services may be different.

In the related arts, a flow split function is provided by a Packet Data Convergence Protocol (PDCP). For example, a PDCP layer may be associated with one entity and the service data is delivered to this entity, and if the PDCP layer is associated with a plurality of entities, a method for sending the service data to the entities can be determined according to specific scenarios.

With these methods, in a Radio Access Network (RAN) separation architecture and a Dual-connectivity (DC) scenario, it is not possible to effectively implement the flow split processing for the service data.

To facilitate understanding, terms involved in the present disclosure are first introduced.

In the present disclosure, flow split (also called sub flow) refers to flow split technologies in communication networks. For example, a network device and/or a terminal device can copy or classify data, and transmit and process the copied or classified data through different logical channels (such as bearers, logical channels, etc.) to improve the reliability, efficiency and/or latency of data transmission. In the present disclosure, “flow split” can also be understood as “classifying” or “mapping”, and there is no limitation on this.

In order to better understand a method for transmission configuration disclosed in embodiments of the present disclosure, a communication system to which the embodiments of the present disclosure are applicable is first described below.

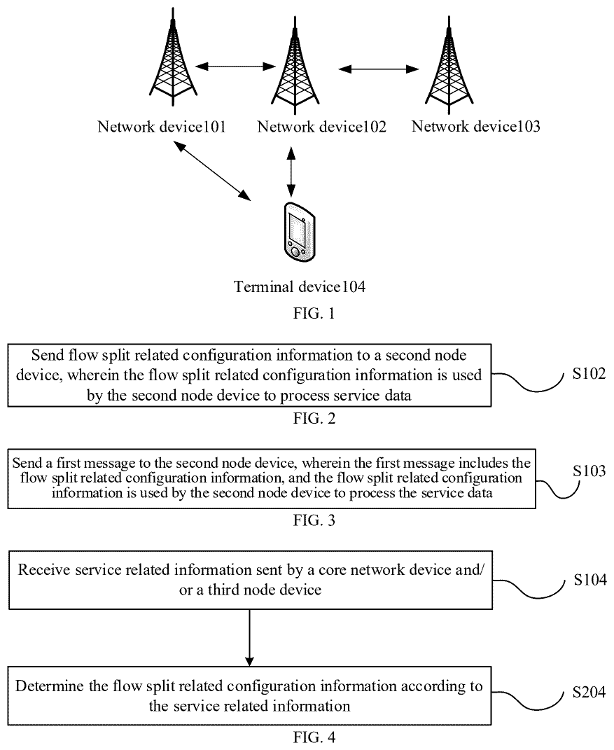

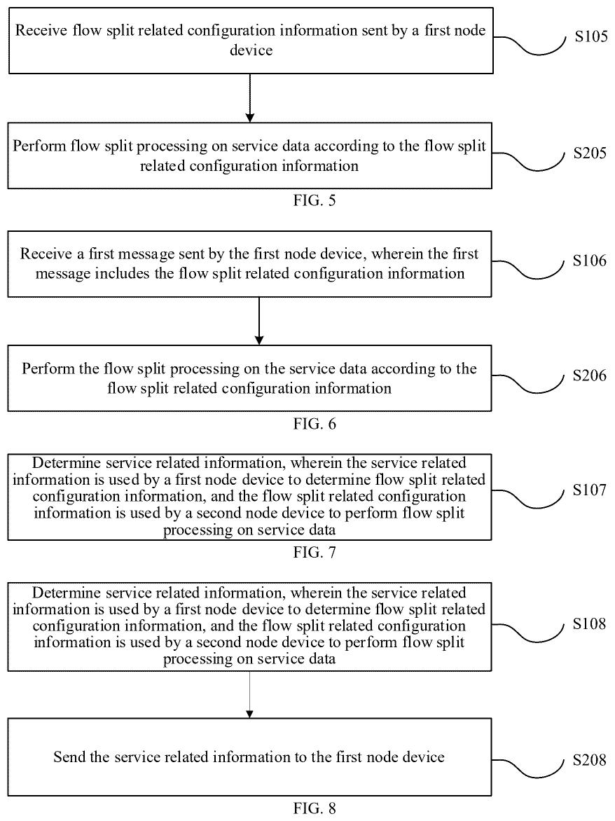

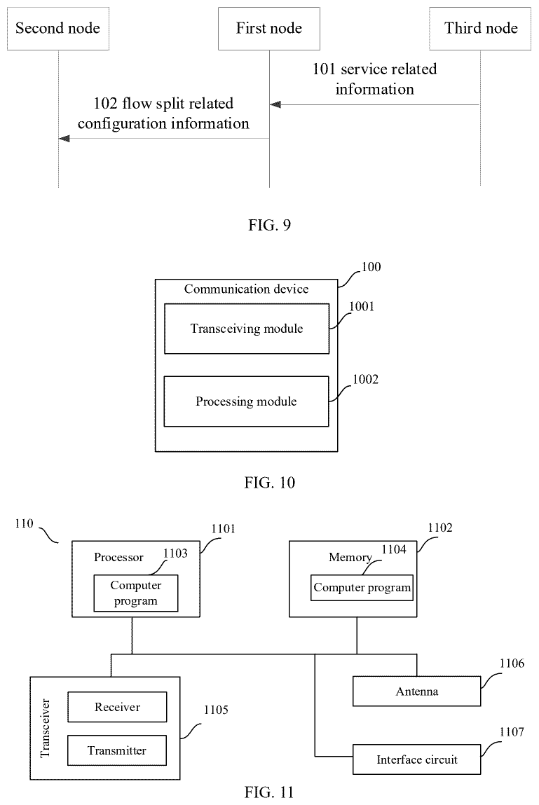

FIG. 1 is a schematic architectural diagram of a communication system provided by an embodiment of the present disclosure. Referring to FIG. 1, the communication system may include, but is not limited to, two network devices and one terminal device. The number and forms of devices shown in FIG. 1 are only as an example and do not constitute a limitation on embodiments of the present disclosure. The communication system may include one or more than two network devices, two or more terminal devices in practical applications. As an example for illustration, the communication system shown in FIG. 1 includes a network device 101, a network device 102, a network device 103 and a terminal device 104.

It should be noted that the technical solutions of embodiments of the present disclosure may be applied to various communication systems, for example, a long term evolution (LTE) system, a 5th generation (5G) mobile communication system, a 5G new radio (NR) system, or other future new mobile communication systems.

The network device 101, the network device 102 and the network device 103 in embodiments of the present disclosure are entities on a network side for transmitting or receiving signals. For example, the network device 101, the network device 102 and the network device 103 may be an evolved NodeB (eNB), a transmission reception point (TRP), a next generation NodeB (gNB) in a NR system, a base station in other future mobile communication systems, or an access node in a wireless fidelity (WiFi) system. Embodiments of the present disclosure do not limit the specific technology and specific device form adopted by the network device.

The network device provided by embodiments of the present disclosure may be composed of a central unit (CU) and a distributed unit (DU). The CU may also be called a control unit. Using the CU-DU structure allows to split a protocol layer of the network device, such as the base station, a part of functions of the protocol layer is centrally controlled in the CU, some or all of the remaining functions of the protocol layer are distributed in the DU, and the CU centrally controls the DU.

The network device 101, the network device 102 and the network device 103 in embodiments of the present disclosure may be base stations, Central Unit Control Planes (CU-CPs), Central Unit User Planes (CU-UPs), or Distributed Units (DUs), etc.

The terminal device 104 in embodiments of the present disclosure is an entity on a user side for receiving or transmitting signals, such as a mobile phone. The terminal device may also be called a terminal, a user equipment (UE), a mobile station (MS), a mobile terminal (MT), and so on. The terminal device may be a car with a communication function, a smart car, a mobile phone, a wearable device, a tablet Pad, a computer with a wireless transceiving function, a virtual reality (VR) terminal device, an augmented reality (AR) terminal device, a wireless terminal device in an industrial control, a wireless terminal device in a self-driving, a wireless terminal device in a remote medical surgery, a wireless terminal device in a smart grid, a wireless terminal device in a transportation safety, a wireless terminal device in a smart city, a wireless terminal device in a smart home, etc.

Embodiments of the present disclosure do not limit the specific technology and the specific device form adopted by the terminal device.

It can be understood that the communication system described in embodiments of the present disclosure is intended to more clearly illustrate the technical solutions of the embodiments of the present disclosure, and are not to be construed as limiting the technical solutions provided by the embodiments of the present disclosure. As will be apparent to those skilled in the art, with evolution of the network architecture and the emergence of new business scenarios, the technical solutions provided by the embodiments of the present disclosure are equally applicable to similar technical problems.

The method and apparatus for transmission configuration provided by the present disclosure are described in detail below with reference to the accompanying drawings. FIG. 2 is a schematic flowchart of a method for transmission configuration provided by an embodiment of the present disclosure. The method is executed by a first node device. The method for transmission configuration in the embodiment can be applied to the first node device, such as a base station, a central unit control plane, a central unit user plane or a distributed unit.

As shown in FIG. 2, the method may include but is not limited to a step S102.

In the S102, flow split related configuration information is sent to a second node device, and the flow split related configuration information is used by the second node device to process service data.

In a Radio Access Network (RAN) separation architecture and a Dual-connectivity (DC) scenario, the first node device and/or the second node device can be used to support communication services (for example, the first node device and/or the second node device can be network devices, which are not limited), and depending on different specific scenarios, there may be no limitation on the type of the first node device and/or the second node device.

In an embodiment of the present disclosure, the first node device may send the flow split related configuration information to the second node device, and the flow split related configuration information is used by the second node device to perform flow split processing on the service data, and the flow split processing method includes, for example, performing entity configuration and packet processing, which is not limited.

That is, the first node device may send the flow split related configuration information to the second node device, and according to the configuration information sent by the first node device, the second node device may perform, on the service data, the flow split processing corresponding to the configuration information.

In some embodiments of the present disclosure, the service includes one or more of an Extended Reality (XR) service, a Virtual Reality (VR) service, and a Cloud Gaming (CG) service, which is not limited.

That is to say, in the present disclosure, the second node device can perform, based on the configuration information sent by the first node device, the entity configuration and the packet processing on the service data of the Extended Reality (XR) service, and/or the Virtual Reality (VR) service, and/or the Cloud Gaming (CG) service.

In the embodiment, the first node device sends the flow split related configuration information to the second node device, and the flow split related configuration information is used by the second node device to perform the flow split processing on the service data, which can effectively expand the application scenarios of the flow split processing for the service data, so that the flow split processing for the service data can be effectively applied to the Radio Access Network (RAN) separation architecture and the Dual-connectivity (DC) scenario.

FIG. 3 is a schematic flowchart of a method for transmission configuration provided by an embodiment of the present disclosure. The method may be executed by the first node device. The method for transmission configuration in the embodiment can be applied to the node device (e.g., the first node device described above), such as the base station, the central unit control plane, the central unit user plane or the distributed unit.

As shown in FIG. 3, the method may include but is not limited to a step S103.

In the S103, a first message is sent to the second node device, and the first message includes the flow split related configuration information, and the flow split related configuration information is used by the second node device to process the service data.

That is to say, the first node device may send the first message to the second node device, and the first message may include the flow split related configuration information. The second node device can receive the first message sent by the first node device, and then obtain the flow split related configuration information from the first message, and perform, on the service data, the flow split processing corresponding to the configuration information.

In the method for transmission configuration provided by embodiments of the present disclosure, corresponding first messages may be used for different types of first node devices and/or second node devices. When the first node device is a gNB-CU or a gNB-CU-CP and the second node device is a gNB-DU, the first message includes at least one of: a UE context setup request message; a UE context modification request message; or an F1 application protocol message. When the first node device is the gNB-CU or the gNB-CU-CP and the second node device is a gNB-CU-UP, the first message includes at least one of: a bearer context setup request message; a bearer context modification request message; or an E1 application protocol message. When the first node device is a Master Node (MN) and the second node device is a Secondary Node (SN), the first message includes at least one of: a Secondary Node (SN) addition request message; a SN modification request message; or an Xn application protocol message. Therefore, the manner of sending the flow split related configuration information can effectively adapt to the type of the first node device and/or the second node device to ensure the accuracy of sending the flow split related configuration information.

For example, the flow split related configuration information may be included in the first message, and the first node device sends the first message to the second node device. The combination of the first node device and the second node device may be illustrated as follows.

A combination of the first node device and the second node device is: the first node device is the gNB-CU or the gNB-CU-CP, and the second node device is the gNB-DU.

Another combination of the first node device and the second node device is: the first node device is the gNB-CU or the gNB-CU-CP, and the second node device is the gNB-CU-UP.

Yet another combination of the first node device and the second node device is: the first node device is the Master Node (MN), and the second node device is the Secondary Node (SN).

In the dual-connectivity scenario, a node that is directly connected to a core network and manages control signaling can be called a Master Node (MN), and the other node in the dual-connectivity scenario can be called a Secondary Node (SN).

In embodiments of the present disclosure, for different combinations of the first node device and/or the second node device, corresponding first messages are used and the flow split related configuration information is included in the first messages, so that the first node device sends the flow split related configuration information to the second node device.

For example, the combination of the first node device and/or the second node device and possible cases of the first message include at least one of the following.

When the first node device is the gNB-CU or the gNB-CU-CP, and the second node device is the gNB-DU, the first message may be the UE context setup request message, the UE context modification request message, or other F1 Application Protocol (F1AP) messages, which is not limited.

When the first node device is the gNB-CU or the gNB-CU-CP, and the second node device is the gNB-CU-UP, the first message may be the bearer context setup request message, the bearer context modification request message, or other E1 Application Protocol (E1AP) messages, which is not limited.

In the dual-connectivity scenario, the first node device is the Master Node (MN), and the second node device is the Secondary Node (SN), and the first message is the SN addition request message, the SN modification request message, or other Xn Application Protocol (XnAP) messages, which is not limited.

In the embodiment, the first message is sent by the first node device to the second node device, the first message includes the flow split related configuration information, and the flow split related configuration information is used by the second node device to perform the flow split processing on the service data, which can effectively improve the sending efficiency of the flow split related configuration information and can effectively expand the application scenarios of the flow split processing for the service data, so that the flow split processing for the service data can be effectively applied to the Radio Access Network (RAN) separation architecture and the Dual-connectivity (DC) scenario.

In the method for transmission configuration provided by embodiments of the present disclosure, the flow split related configuration information may include at least one of: flow split indication information, and the flow split indication information is configured to indicate the second node device to establish at least two entities; flow split quantity information, and the flow split quantity information is configured to indicate the second node device to establish entities, the number of which corresponds to a flow split quantity indicated by the flow split quantity information; mapping relationship information, and the mapping relationship information is configured to indicate a mapping relationship between data packets and entities to which the data packets are to be flow split; or flow split type information, and the flow split type information is configured to indicate the second node device to perform, on uplink and/or downlink data related to the flow split type information, processing related to the flow split type information.

Therefore, the flow split related configuration information indicated by the first node device to the second node device is effectively expanded, so that the second node device can realize the personalized flow split processing for the service data based on the flow split related configuration information indicated by the first node device, thereby facilitating the effective expansion and implementation of the flow split of the service data in a plurality of communication application scenarios.

For example, the flow split related configuration information may include at least one of:
the flow split indication information, and the second node device can establish at least two entities according to the flow split indication information;
the flow split quantity information, and the second node device can establish, according to the flow split quantity indicated by the flow split quantity information, entities whose quantity is the corresponding flow split quantity;
the mapping relationship information, which refers to a mapping relationship between the data packets of the service and the entities; for example, data packets with different priorities or frame types can be correspondingly mapped to different entities; and the data packets of the service can be flow split by the second node device, according to the mapping relationship information, to the entities corresponding to the data packets of the service indicated by the mapping relationship; or
the flow split type information, and the flow split type information is configured to indicate the second node device to perform, on the uplink and/or downlink data related to the flow split type information, processing related to the flow split type information: for example, for DownLink (DL) data, UpLink (UL) data or DL+UL data, the second entity performs corresponding processing on the DL data, the UL data or the DL+UL data according to the flow split type information.

In the method for transmission configuration provided by embodiments of the present disclosure, the entity may include one or more of a Radio Link Control (RLC) entity, a Packet Data Convergence Protocol (PDCP) entity, and a Media Access Control (MAC) entity, which is not limited.

In the method for transmission configuration provided by embodiments of the present disclosure, the first node device can also determine the flow split related configuration information based on the service related information, so that the flow split processing for the service data can effectively adapt to the actual situation and needs of the service, thereby improving the accuracy of the flow split processing for the service data.

In the method for transmission configuration provided by embodiments of the present disclosure, the service related information includes at least one of: Protocol Data Unit (PDU) set indication: sub Quality of Service (sub-QoS) flow indication, service type indication, or data type indication, thereby effectively improving the comprehensiveness of the indication of the service related information, and facilitating the first node device to accurately determine the flow split related configuration information based on the service related information.

The PDU set indication is configured to indicate a PDU set related to the service, the sub-QoS flow indication is configured to indicate a sub-QoS flow related to the service, the service type indication is configured to indicate a type of the service, and the data type indication is configured to indicate a type of the data, including I frame or P frame, the priority, etc.

FIG. 4 is a schematic flowchart of a method for transmission configuration provided by an embodiment of the present disclosure. The method is executed by a first node device. The method for transmission configuration in the embodiment can be applied to the first node device, such as the base station, the central unit control plane, the central unit user plane or the distributed unit.

As shown in FIG. 4, the method may include but is not limited to steps S104 and S204.

In the S104, service related information sent by a core network device and/or a third node device is received.

That is to say, the first node device can determine the flow split related configuration information based on the service related information, and when the first node device obtains the service related information, it can receive the information related to the service from the core network device and/or the third node device. That is, the first node device can receive the service related information sent by the core network device and/or the third node device.

In the method for transmission configuration provided by embodiments of the present disclosure, receiving the service related information sent by the core network device and/or the third node device and may include at least one of: receiving, through a control plane, the service related information sent by the core network device and/or the third node device: receiving, through a user plane, the service related information sent by the core network device and/or the third node device, thereby effectively expanding the way of sending the service related information.

For example, the service related information may be sent by the third node device to the first node device through the control plane and/or the user plane. The first node device may be the base station or the control plane of the base station (for example, the gNB-CU, the gNB-CU-CP), and the third node device may be the base station, the user plane of the base station (the gNB-CU-UP) or the core network device, and the core network device may be, for example, a Session Management Function (SMF) network element or an Access and Mobility Management Function (AMF) network element.

In the S204, the flow split related configuration information is determined according to the service related information.

After receiving the service related information sent by the core network device and/or the third node device, the first node device can determine the flow split related configuration information based on the service related information. For example, the first node device can analyze the service related information to determine a flow split processing logic for the service data, so as to generate the flow split related configuration information based on the flow split processing logic for the service data, which is not limited.

In the embodiment, the service related information sent by the core network device and/or the third node device is received, and the flow split related configuration information is determined according to the service related information, so that the flow split processing for the service data can be effectively adapted to the actual situation of the service, and the accuracy of the flow split processing for the service data is improved. In addition, the service related information can be indicated by the core network device and/or the third node device, so that the indication method of the service related information can also be effectively applicable to the Radio Access Network (RAN) separation architecture and the Dual-connectivity (DC) scenario.

In the method for transmission configuration provided by embodiments of the present disclosure, the first node device may also receive a second message sent by the core network device and/or the third node device, and the second message includes the service related information.

In response to the service related information being received through the control plane, when the first node device is the base station and the third node device is the core network device, the second message includes at least one of: a UE context setup message; a PDU session resource setup request message; a PDU session resource modification request message; a handover request message; or a NG Application Protocol (NGAP) message; when the first node device is a source base station in the handover process and the third node device is a destination base station in the handover process, the second message includes at least one of: the handover request message; or an Xn application protocol message; when the first node device is the Master Node (MN) in the Dual-connectivity (DC) scenario and the third node device is the Secondary Node (SN) in the DC scenario, the second message includes at least one of: a SN addition request message; a SN modification request message; or the Xn application protocol message; when the first node device is a serving base station of the user equipment (UE), and the third node device is an anchor base station or a last serving base station of the UE, the second message includes at least one of: a retrieve UE context feedback message; or the Xn application protocol message. If the service related information is received by the first node device through the user plane, then when the first node device is the gNB-CU-CP and the third node device is the gNB-CU-UP, the second message includes a bearer context modification request message, or an E1 application protocol message.

Therefore, the way of receiving the service related information can effectively adapt to the type of the first node device and/or the third node device to ensure the accuracy of receiving the service related information. In addition, the core network device and/or the third node device sends the second message to the first node device, and the second message includes the service related information, which can effectively improve the efficiency of sending the service related information.

For example, in response to the service related information being received through the control plane, the service related information may be included in the second message, and the combination of the first node device, the core network device, the third node device, and the type of the second message may be illustrated as follows.

If the first node device is the base station and the service related information is sent by the core network device, the core network device can be the SMF network element or the AMF network element, and the second message is the UE context setup message, the PDU session resource setup request message, the PDU session resource modification request message, the handover request message or other NGAP messages, which is not limited.

If the first node device is the source base station in the handover process, the service related information is sent by the third node device, and the third node device is the destination base station in the handover process, the second message may be the handover request message or other XnAP messages, which is not limited.

If the first node device is the Master Node (MN) in the Dual-connectivity (DC) scenario, the service related information is sent by the third node device, and the third node device is the Secondary Node (SN) in the DC scenario, the second message is the SN addition request message, the SN modification request message or other XnAP messages, which is not limited.

If the first node is the serving base station (e.g., the serving gNB) or a new serving base station (e.g., the new serving gNB) of the UE, and the third node is the anchor gNB or the last serving base station (e.g., the last serving gNB) of the UE, the second message may be the retrieve UE context feedback message or other XnAP messages, which is not limited.

For example, in response to the service related information being received through the user plane, when the third node device identifies the service related information in a General Packet Radio Service (GPRS) Tunnelling Protocol for the user plane (GTP-U) packet header, the third node device may send the service related information to the first node device through the E1AP message, so that the first node device instructs the second node device to establish a corresponding entity to meet the flow split requirements of the service data.

In some embodiments of the present disclosure, the E1AP message may be the bearer context modification request message or other E1AP messages, which is not limited.

It can be understood that the steps of the embodiment in FIG. 4 can be implemented alone or in combination with steps of other embodiments of the present disclosure. For example, the steps of the embodiment in FIG. 4 can be implemented in combination with the step of the embodiment shown in FIG. 3, which is not limited.

For the description of the same or corresponding terms as in the above embodiments, reference may be made to the above embodiments for details, which will not be repeated here.

FIG. 5 is a schematic flowchart of another method for transmission configuration provided by an embodiment of the present disclosure. The method is executed by a second node device. The method for transmission configuration in the embodiment can be applied to the second node device, such as the base station, the central unit control plane, the central unit user plane or the distributed unit.

As shown in FIG. 5, the method may include but is not limited to steps S105 and S205.

In the S105, flow split related configuration information sent by a first node device is received.

In the method for transmission configuration provided by embodiments of the present disclosure, the flow split related configuration information includes at least one of: flow split indication information, and the flow split indication information is configured to indicate the second node device to establish at least two entities; flow split quantity information, and the flow split quantity information is configured to indicate the second node device to establish entities, the number of which corresponds to a flow split quantity indicated by the flow split quantity information: mapping relationship information, and the mapping relationship information is configured to indicate a mapping relationship between data packets and entities to which the data packets are to be flow split; or flow split type information, and the flow split type information is configured to indicate the second node device to perform, on uplink and/or downlink data related to the flow split type information, processing related to the flow split type information.

In the method for transmission configuration provided by embodiments of the present disclosure, the entity may include one or more of a Radio Link Control (RLC) entity, a Packet Data Convergence Protocol (PDCP) entity, and a Media Access Control (MAC) entity, which is not limited.

In the S205, flow split processing is performed on service data according to the flow split related configuration information.

In the embodiment, the second node device receives the flow split related configuration information sent by the first node device, and performs the flow split processing on the service data according to the flow split related configuration information, which can effectively expand the application scenarios of the flow split processing for the service data, so that the flow split processing for the service data can be effectively applied to the Radio Access Network (RAN) separation architecture and the Dual-connectivity (DC) scenario.

FIG. 6 is a schematic flowchart of another method for transmission configuration provided by an embodiment of the present disclosure. The method is executed by a second node device. The method for transmission configuration in the embodiment can be applied to the second node device, such as the base station, the central unit control plane, the central unit user plane or the distributed unit.

As shown in FIG. 6, the method may include but is not limited to steps S106 and S206.

In the S106, a first message sent by the first node device is received, and the first message includes the flow split related configuration information.

In the method for transmission configuration provided by embodiments of the present disclosure, when the first node device is a gNB-CU or a gNB-CU-CP and the second node device is a gNB-DU, the first message includes at least one of: a UE context setup request message; a UE context modification request message; or an F1 application protocol message. When the first node device is the gNB-CU or the gNB-CU-CP and the second node device is a gNB-CU-UP, the first message includes at least one of: a bearer context setup request message; a bearer context modification request message; or an E1 application protocol message. When the first node device is a Master Node (MN) and the second node device is a Secondary Node (SN), the first message includes at least one of: a Secondary Node (SN) addition request message; a SN modification request message; or an Xn application protocol message.

In the S206, the flow split processing is performed on the service data according to the flow split related configuration information.

In the embodiment, the second node device receives the first message sent by the first node device, and performs the flow split processing on the service data based on the flow split related configuration information in the first message, which can effectively improve the efficiency of receiving the flow split related configuration information, and can effectively expand the application scenarios of the flow split processing for the service data, so that the flow split processing for the service data can be effectively applied to the Radio Access Network (RAN) separation architecture and the Dual-connectivity (DC) scenario.

In the method for transmission configuration provided by embodiments of the present disclosure, the flow split related configuration information is determined by the service related information.

In the method for transmission configuration provided by embodiments of the present disclosure, the service related information includes at least one of: Protocol Data Unit (PDU) set indication: sub Quality of Service (sub-QoS) flow indication, service type indication, or data type indication.

In the method for transmission configuration provided by embodiments of the present disclosure, the service includes at least one of an Extended Reality (XR) service, a Virtual Reality (VR) service, or a Cloud Gaming (CG) service.

FIG. 7 is a schematic flowchart of yet another method for transmission configuration provided by an embodiment of the present disclosure. The method is executed by a core network device and/or a third node device. The method for transmission configuration in the embodiment can be applied to the core network device and/or the third node device, the third node device may be, for example, the base station, the central unit control plane, the central unit user plane or the distributed unit. The core network device may be, for example, the SMF network element or the AMF network element.

As shown in FIG. 7, the method may include but is not limited to a step S107.

In the S107, service related information is determined, the service related information is used by a first node device to determine flow split related configuration information, and the flow split related configuration information is used by a second node device to perform flow split processing on service data.

In the method for transmission configuration provided by embodiments of the present disclosure, the service related information includes at least one of: Protocol Data Unit (PDU) set indication: sub Quality of Service (sub-QoS) flow indication, service type indication, or data type indication.

For example, the core network device and/or the third node device can analyze the service related Protocol Data Unit (PDU) set, the service related sub Quality of Service (sub-QoS) flow, and the service related service type, and then form the Protocol Data Unit (PDU) set indication, the sub Quality of Service (sub-QoS) flow indication and the service type indication as the service related information, so as to support, based on the service related information, the first node device to determine the flow split related configuration information, and the flow split related configuration information is used to support the second node device to perform the flow split processing on the service data.

In the method for transmission configuration provided by embodiments of the present disclosure, the service includes at least one of an Extended Reality (XR) service, a Virtual Reality (VR) service, or a Cloud Gaming (CG) service.

In the embodiment, the core network device and/or the third node device determines the service related information, and the service related information is used by the first node device to determine the flow split related configuration information, and the flow split related configuration information is used by the second node device to perform the flow split processing on the service data, which can effectively assist in expanding the application scenarios of the flow split processing for the service data, so that the flow split processing for the service data can be effectively applied to the Radio Access Network (RAN) separation architecture and the Dual-connectivity (DC) scenario.

FIG. 8 is a schematic flowchart of still another method for transmission configuration provided by an embodiment of the present disclosure. The method is executed by a core network device and/or a third node device. The method for transmission configuration in the embodiment can be applied to the core network device and/or the third node device, the third node device may be, for example, the base station, the central unit control plane, the central unit user plane or the distributed unit. The core network device may be, for example, the SMF network element or the AMF network element.

As shown in FIG. 8, the method may include but is not limited to steps S108 and S208.

In the S108, service related information is determined, the service related information is used by a first node device to determine flow split related configuration information, and the flow split related configuration information is used by a second node device to perform flow split processing on service data.

In the S208, the service related information is sent to the first node device.

In the method for transmission configuration provided by embodiments of the present disclosure, sending the service related information to the first node device includes at least one of: sending the service related information to the first node device through a control plane; or sending the service related information to the first node device through a user plane, thereby effectively improving the flexibility of the core network device and/or the third node device in sending the service related information to the first node device, so that the way of sending the service related information can be effectively applied to personalized communication scenario requirements.

In the method for transmission configuration provided by embodiments of the present disclosure, the core network device and/or the third node device may send a second message to the first node device, and the second message includes the service related information.

In response to the service related information being sent through the control plane, when the first node device is the base station and the third node device is the core network device, the second message includes at least one of: a UE context setup message; a PDU session resource setup request message; a PDU session resource modification request message; a handover request message; or a NG Application Protocol (NGAP) message; when the first node device is a source base station in the handover process and the third node device is a destination base station in the handover process, the second message includes at least one of: the handover request message; or an Xn application protocol message; when the first node device is the Master Node (MN) in the Dual-connectivity (DC) scenario and the third node device is the Secondary Node (SN) in the DC scenario, the second message includes at least one of: a SN addition request message; a SN modification request message; or the Xn application protocol message; when the first node device is a serving base station of the user equipment (UE), and the third node device is an anchor base station or a last serving base station of the UE, the second message includes at least one of: a retrieve UE context feedback message; or the Xn application protocol message. In response to the service related information being sent through the user plane, the second message includes at least one of: a bearer context modification request message; or an E1 application protocol message.

The application description of the method for transmission configuration provided by embodiments of the present disclosure can be specifically as follows.

As shown in FIG. 9, FIG. 9 is a schematic flowchart of still another method for transmission configuration provided by an embodiment of the present disclosure.

A first node corresponds to the first node device in the above embodiments, a second node corresponds to the second node device in the above embodiments, and a third node corresponds to the third node device in the above embodiments.

In step 101, the first node receives service related information from the third node, and the first node determines flow split related configuration information based on the service related information.

In some embodiments, the service related information includes at least one of:
PDU set indication,
Sub-QoS flow indication,
service type indication (e.g. XR, VR, CG, etc.), or
data type indication (e.g. I-frame, P-frame, priority, etc.).

In some embodiments, the service related information is included in a second message sent by the third node to the first node. Possible situations include the following.

According to an embodiment, the first node is the base station, the third node is the core network device, the core network device may be the SMF or the AMF, and the second message is the UE context setup message, the PDU session resource setup request message, the PDU session resource modification request message, the handover request message or other NGAP messages.

According to another embodiment, the first node is the source base station in the handover process, the third node is the destination base station in the handover process, and the second message is the handover request message or other XnAP messages.

According to yet another embodiment, the first node is the Master Node (MN) in the Dual-connectivity (DC) scenario, the third node is the Secondary Node (SN) in the DC scenario, and the second message is the SN addition request message, the SN modification request message or other XnAP messages.

According to still another embodiment, the first node is the serving base station (e.g., the serving gNB or the new serving gNB) of the UE, the third node is the anchor base station or the last serving base station (e.g., the last serving gNB) of the UE, and the second message is the retrieve UE context feedback message or other XnAP messages.

According to still another embodiment, the first node is the CU-CP in the RAN separation architecture, the third node is the CU-UP in the RAN separation architecture, and the second message is the bearer context modification request message or other E1AP messages.

In the step 102, the first node sends flow split related configuration information to the third node, and the second node performs entity configuration and packet processing according to the flow split related configuration information.

In some embodiments, the flow split related configuration information is included in a first message sent by the first node to the second node. Possible situations include the following.

According to an embodiment, the first node is the gNB-CU or the gNB-CU-CP, the second node is the gNB-DU, and the first message may be the UE context setup request message, the UE context modification request message, or other F1AP messages.

According to another embodiment, the first node is the gNB-CU or the gNB-CU-CP, the second node is the gNB-CU-UP, and the first message may be the bearer context setup request message, the bearer context modification request message, or other E1AP messages.

According to yet another embodiment, the first node is the MN, the second node is the SN, and the first message is the SN addition request message, the SN modification request message, or other XnAP messages.

In some embodiments, the flow split related configuration information includes at least one of: flow split indication (corresponding to the flow split indication information in the above-mentioned embodiments), and the second node establishes at least two first entities according to the flow split indication: flow split quantity information, and the second node establishes, according to the flow split quantity, first entities, the number of which corresponds to the quantity indicted by the information: mapping relationship information, which refers to a mapping relationship between packets and entities, for example, packets with different priorities or frame types can be mapped to different entities, and the corresponding packets are flow split by the second node splits to the corresponding first entity according to the mapping relationship information; or flow split type information, for example, for DL, UL or DL+UL, the second node performs corresponding processing on the uplink and downlink data according to the flow split type information.

In some embodiments, the mapping relationship information may be represented by an enumerated frame type, for example, ENUMERATED {I frame, P frame}, or may be represented by INTEGER (1 . . . X), where X is an integer greater than 1. For example, the arrangement is performed in descending order of priority, that is, 1 is the highest priority and X is the lowest priority, or the arrangement is performed in ascending order of priority, that is, 1 is the lowest priority and X is the highest priority.

In some embodiments, the flow split indication and the flow split quantity information may be represented by the same information, for example, Flow Split Indication or ENUMERATED {two, three, . . . }.

In some embodiments, the flow split quantity information and the mapping relationship information are represented by a list IE, as shown in Table 1 and Table 2 below, which is not limited.

TABLE 1

| | | | |
|---|---|---|---|
| >> UL UP Transport Network Layer | | 1 | |
| (TNL) Information to be setup List | | | |
| >>>UL UP TNL Information to Be Setup | | 1 . . . | |
| Item Information Elements (IEs) | | <maxnoofULUPTNLInformation> | |
| >>>>UL UP TNL Information | M | | UP Transport Layer Information |
| | (mandatory) | | |
| >>>>packet Mapping Info | O | | ENUMERATED {I frame, P |
| | (optional) | | frame} |

TABLE 2

| | | | |
|---|---|---|---|
| >> RLC entity configuration List | | 1 | |
| >>>RLC entity configuration item | | 1 . . . | |
| | | <maxnoofRLCEntity> | |
| >>>>packet Mapping Info | M | | ENUMERATED {I frame, P |
| | (mandatory) | | frame} |

maxnoofULUPTNLInformation is the maximum number of uplink user plane transmission network information.
maxnoofRLCEntity is the maximum number of RLC entities corresponding to one PDCP entity.
packet Mapping Info can be represented by an enumerated frame type (ENUMERATED {I frame, P frame}), or by INTEGER (1 . . . X), where X is an integer greater than 1. For example, the arrangement is performed in descending order of priority, that is, 1 is the highest priority and X is the lowest priority, or the arrangement is performed in ascending order of priority, that is, 1 is the lowest priority and X is the highest priority.

It is understood that each element in Table 1 or Table 2 exists independently. These elements are exemplarily listed in the same table, but it does not mean that all elements in the table must exist at the same time as shown in the table. The value of each element is independent of the value of any other element in Table 1 or Table 2. Therefore, those skilled in the art can understand that the value of each element in Table 1 or Table 2 is an independent embodiment.

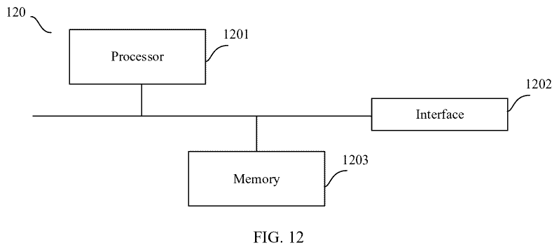

FIG. 10 is a schematic structural diagram of a communication device provided by an embodiment of the present disclosure. The communication device 100 shown in FIG. 10 may include a transceiving module 1001 and a processing module 1002. The transceiving module 1001 may include a transmitting module and/or a receiving module, the transmitting module is configured to implement a transmitting function, the receiving module is configured to implement a receiving function, and the transceiving module 1001 may implement a transmitting function and/or a receiving function.

The communication device 100 may be a network device (such as the second node device in the aforementioned method embodiment), or a device in the second node device, or a device that can be used in conjunction with the second node device. Alternatively, the communication device 100 may be a network device (such as the first node device and/or the core network device and/or the third node device in the aforementioned method embodiment), or a device in the network device, or a device that can be used in conjunction with the network device.

The communication device 100 on the first node device side includes:
the transceiving module 1001, configured to send flow split related configuration information to a second node device, and the flow split related configuration information is used by a second node device to process service data.

In an embodiment of the present disclosure, a first message is sent to the second node device, and the first message includes the flow split related configuration information:
wherein, in a case where the first node device is a gNB-CU or a gNB-CU-CP, and the second node device is a gNB-DU, the first message includes at least one of:
a UE context setup request message;
a UE context modification request message; or
a F1 application protocol message;
in a case where the first node device is the gNB-CU or the gNB-CU-CP, and the second node device is a gNB-CU-UP, the first message includes at least one of:
a bearer context setup request message;
a bearer context modification request message; or
an E1 application protocol message;
in a case where the first node device is a Master Node (MN), and the second node device is a Secondary Node (SN), the first message includes at least one of:
a Secondary Node (SN) addition request message;
a SN modification request message; or
an Xn application protocol message.

In an embodiment of the present disclosure, the flow split related configuration information includes at least one of:
flow split indication information, wherein the flow split indication information is configured to indicate the second node device to establish at least two entities;
flow split quantity information, wherein the flow split quantity information is configured to indicate the second node device to establish entities whose quantity is a flow split quantity indicated by the flow split quantity information;
mapping relationship information, wherein the mapping relationship information is configured to indicate a mapping relationship between a data packet and an entity to which the data packet is to be flow split; or
flow split type information, wherein the flow split type information is configured to indicate the second node device to perform, on uplink data and/or downlink data related to the flow split type information, processing related to the flow split type information.

In an embodiment of the present disclosure, the entity includes at least one of:
a Radio Link Control (RLC) entity;
a Packet Data Convergence Protocol (PDCP) entity; or
a Media Access Control (MAC) entity.

In an embodiment of the present disclosure, the method further includes:
determining the flow split related configuration information according to service related information.

In an embodiment of the present disclosure, determining the flow split related configuration information according to the service related information includes:
receiving the service related information sent by a core network device and/or a third node device; and
determining the flow split related configuration information according to the service related information.

In an embodiment of the present disclosure, receiving the service related information sent by the core network device and/or the third node device includes at least one of:
receiving, through a control plane, the service related information sent by the core network device and/or the third node device; or
receiving, through a user plane, the service related information sent by the core network device and/or the third node device.

In an embodiment of the present disclosure, the method further includes:
receiving a second message sent by the core network device and/or the third node device, wherein the second message includes the service related information;
wherein in response to the service related information being received through a control plane:
in a case where the first node device is a base station, and the third node device is a core network device, the second message includes at least one of:
a UE context setup message;
a PDU session resource setup request message;
a PDU session resource modification request message;
a handover request message; or
a NG Application Protocol (NGAP) message;
in a case where the first node device is a source base station in a handover process, and the third node device is a destination base station in the handover process, the second message includes at least one of:
the handover request message; or
an Xn application protocol message;
in a case where the first node device is a Master Node (MN) in a Dual-connectivity (DC) scenario, and the third node device is a Secondary Node (SN) in the DC scenario, the second message includes at least one of:
a SN addition request message;
a SN modification request message; or
the Xn application protocol message;
in a case where the first node device is a serving base station of a User Equipment (UE), and the third node device is an anchor base station or a last serving base station of the UE, the second message includes at least one of:
a retrieve UE context feedback message; or
the Xn application protocol message;
in response to the service related information being received through a user plane, the second message includes at least one of:
a bearer context modification request message; or
an E1 application protocol message.

In an embodiment of the present disclosure, the service related information includes at least one of:

Protocol Data Unit (PDU) set indication:
sub-Quality of Service (sub-QoS) flow indication;
service type indication; or
data type indication

In an embodiment of the present disclosure, the service includes at least one of:
an Extended Reality (XR) service;
a Virtual Reality (VR) service; or
a Cloud Gaming (CG) service.

In the embodiment, the first node device sends the flow split related configuration information to the second node device, and the flow split related configuration information is used by the second node device to perform the flow split processing on the service data, which can effectively expand the application scenarios of the flow split processing for the service data, so that the flow split processing for the service data can be effectively applied to the Radio Access Network (RAN) separation architecture and the Dual-connectivity (DC) scenario.

The communication device 100 on the second node device side includes:
the transceiving module 1001, configured to receive flow split related configuration information sent by a first node device; and
the processing module 1002, configured to perform flow split processing on data of a service according to the flow split related configuration information.

In an embodiment of the present disclosure, the method further includes:
receiving a first message sent by the first node device, wherein the first message includes the flow split related configuration information;
wherein, in a case where the first node device is a gNB-CU or a gNB-CU-CP, and the second node device is a gNB-DU, the first message includes at least one of:
a UE context setup request message;
a UE context modification request message; or
a F1 application protocol message;
in a case where the first node device is the gNB-CU or the gNB-CU-CP, and the second node device is a gNB-CU-UP, the first message includes at least one of:
a bearer context setup request message;
a bearer context modification request message; or
an E1 application protocol message;
in a case where the first node device is a Master Node (MN), and the second node device is a Secondary Node (SN), the first message includes at least one of:
a Secondary Node (SN) addition request message;
a SN modification request message; or
an Xn application protocol message.

In an embodiment of the present disclosure, the flow split related configuration information includes at least one of:
flow split indication information, wherein the flow split indication information is configured to indicate the second node device to establish at least two entities;
flow split quantity information, wherein the flow split quantity information is configured to indicate the second node device to establish entities whose quantity is a flow split quantity indicated by the flow split quantity information;
mapping relationship information, wherein the mapping relationship information is configured to indicate a mapping relationship between a data packet and an entity to which the data packet is to be flow split; or
flow split type information, wherein the flow split type information is configured to indicate the second node device to perform, on uplink data and/or downlink data related to the flow split type information, processing related to the flow split type information.

In an embodiment of the present disclosure, the entity includes at least one of:
a Radio Link Control (RLC) entity;
a Packet Data Convergence Protocol (PDCP) entity; or
a Media Access Control (MAC) entity.

In an embodiment of the present disclosure, the flow split related configuration information is determined by service related information.

In an embodiment of the present disclosure, the service related information includes at least one of:

Protocol Data Unit (PDU) set indication;
sub-Quality of Service (sub-QoS) flow indication;
service type indication; or
data type indication.

In an embodiment of the present disclosure, the service includes at least one of:
an Extended Reality (XR) service;
a Virtual Reality (VR) service; or
a Cloud Gaming (CG) service.

In the embodiment, the second node device receives the flow split related configuration information sent by the first node device, and performs the flow split processing on the service data according to the flow split related configuration information, which can effectively expand the application scenarios of the flow split processing for the service data, so that the flow split processing for the service data can be effectively applied to the Radio Access Network (RAN) separation architecture and the Dual-connectivity (DC) scenario.

The communication device 100 on the core network device and/or the third node device side includes:
the processing module 1002, configured to determine service related information, wherein the service related information is used by a first node device to determine flow split related configuration information, and the flow split related configuration information is used by a second node device to perform flow split processing on data of a service.

In an embodiment of the present disclosure, the method further includes:
sending the service related information to the first node device.

In an embodiment of the present disclosure, sending the service related information to the first node device includes at least one of:
sending the service related information to the first node device through a control plane; or
sending the service related information to the first node device through a user plane.

In an embodiment of the present disclosure, the method further includes:
sending a second message to the first node device, wherein the second message includes the service related information;
wherein, in response to the service related information being sent through a control plane; in a case where the first node device is a base station, and the third node device is a core network device, the second message includes at least one of:
a UE context setup message;
a PDU session resource setup request message;
a PDU session resource modification request message;
a handover request message; or
a NG Application Protocol (NGAP) message;
in a case where the first node device is a source base station in a handover process, and the third node device is a destination base station in the handover process, the second message includes at least one of:
the handover request message; or
an Xn application protocol message;
in a case where the first node device is a Master Node (MN) in a Dual-connectivity (DC) scenario, and the third node device is a Secondary Node (SN) in the DC scenario, the second message includes at least one of:
a SN addition request message;
a SN modification request message; or
the Xn application protocol message;
in a case where the first node device is a serving base station of a User Equipment (UE), and the third node device is an anchor base station or a last serving base station of the UE, the second message includes at least one of:
a retrieve UE context feedback message; or
the Xn application protocol message;
in response to the service related information being sent through a user plane, the second message includes at least one of:
a bearer context modification request message; or
an E1 application protocol message.

In an embodiment of the present disclosure, the service related information includes at least one of:

Protocol Data Unit (PDU) set indication;
sub-Quality of Service (sub-QoS) flow indication;
service type indication; or
data type indication.

In an embodiment of the present disclosure, the service includes at least one of:
an Extended Reality (XR) service;
a Virtual Reality (VR) service; or
a Cloud Gaming (CG) service.

In the embodiment, the core network device and/or the third node device determines the service related information, and the service related information is used by the first node device to determine the flow split related configuration information, and the flow split related configuration information is used by the second node device to perform the flow split processing on the service data, which can effectively assist in expanding the application scenarios of the flow split processing for the service data, so that the flow split processing for the service data can be effectively applied to the Radio Access Network (RAN) separation architecture and the Dual-connectivity (DC) scenario.

FIG. 11 is a schematic structural diagram of another communication device provided by an embodiment of the present disclosure. The communication device 110 may be a network device (such as the first node device, the second node device, the core network device and/or the third node device in the aforementioned method embodiment), or may be a chip, a chip system, or a processor that supports the network device to implement the aforementioned method. The device may be configured to implement the method as described in the above method embodiments, and for details, reference may be made to the descriptions in the above method embodiments.

The communication device 110 may include one or more processors 1101. The processor 1101 may be a general-purpose processor or a special-purpose processor. For example, it may be a baseband processor or a central processing unit. The baseband processor may be configured to process a communication protocol and communication data, and the central processing unit may be configured to control a communication device (such as a base station, a baseband chip, the terminal device, a terminal device chip, a DU or a CU, etc.) execute computer programs, and process data of computer programs.

In an embodiment, the communication device 110 may further include one or more memories 1102 having stored therein a computer program 1104. The processor 1101 may store the computer program 1103, and the processor 1101 executes the computer program 1104 and/or the computer program 1103 to cause the communication device 110 to implement the method as described in the above method embodiments.

In an embodiment, the memory 1102 may have stored therein data. The communication device 110 and the memory 1102 may be set separately or integrated together.

In an embodiment, the communication device 110 may further include a transceiver 1105 and an antenna 1106. The transceiver 1105 may be called a transceiving unit, a transceiving machine, a transceiving circuit or the like, for implementing a transceiving function. The transceiver 1105 may include a receiver and a transmitter. The receiver may be called a receiving machine, a receiving circuit or the like, for implementing a receiving function. The transmitter may be called a sending machine, a sending circuit or the like for implementing a sending function.

In an embodiment, the communication device 110 may further include one or more interface circuits 1107. The interface circuit 1107 is configured to receive a code instruction and transmit the code instruction to the processor 1101. The processor 1101 runs the code instruction to enable the communication device 110 to execute the methods as described in the foregoing method embodiments.

In an implementation of the present disclosure, the processor 1101 may include a transceiver for implementing receiving and transmitting functions. For example, the transceiver may be a transceiver circuit, an interface, or an interface circuit. The transceiver circuits, interfaces or interface circuits used to implement the receiving and transmitting functions can be separate or integrated together. The transceiver circuit, interface or interface circuit can be used for reading and writing codes/data, or the transceiver circuit, interface or interface circuit can be used for signal transmission or transfer.

In an implementation of the present disclosure, the processor 1101 may be stored with a computer program 1103, and the computer program 1103 is performed by the processor 1101, causing the communication device 110 to perform the method described in the above method embodiments. The computer program 1103 may be solidified in the processor 1101, in which case the processor 1101 may be implemented by hardware.

In an implementation of the present disclosure, the communication device 110 may include a circuit, and the circuit may implement the functions of sending or receiving or communicating in the foregoing method embodiments. The processors and transceivers described in the present disclosure may be implemented on an integrated circuit (IC), an analog IC, a radio frequency integrated circuit (RFIC), a mixed signal IC, an application specific integrated circuit (ASIC), a printed circuit boards (PCB), an electronic device, and the like. The processor and transceiver can also be manufactured using various IC process technologies, such as complementary metal oxide semiconductor (CMOS), N-type metal oxide semiconductor (nMetal-oxide-semiconductor, NMOS), P-type metal oxide semiconductor (positive channel metal oxide semiconductor, PMOS), bipolar junction transistor (BJT), bipolar CMOS (BiCMOS), silicon germanium (SiGe), gallium arsenide (GaAs), and the like.

The communication device described in the above embodiments may be the network device (e.g., the first node device, the second node device, the core network device and/or the third node device in the above method embodiments), but the scope of the communication device described in the present disclosure is not limited thereto, and the structure of the communication device may not be limited by FIG. 11. The communication device may be a stand-alone device or may be part of a larger device. For example, the communication device may be:
(1) a stand-alone integrated circuit IC, or chip, or chip system or subsystem;
(2) a set of one or more ICs. In embodiments of the present disclosure, the IC set may further include storage components for storing data and computer programs;
(3) an ASIC, such as a modem;
(4) a module that can be embedded in another device;
(5) a receiver, a terminal device, an intelligent terminal device, a cellular phone, a wireless device, a handheld device, a mobile unit, a vehicle-mounted device, a network device, a cloud device, an artificial intelligence device, and the like;
(6) others, etc.

For the case where the communication device may be a chip or a chip system, reference may be made to FIG. 12, which is a schematic structural diagram of a chip according to an embodiment of the present disclosure. The chip shown in FIG. 12 includes a processor 1201 and an interface 1202. In the chip, one or more processors 1201 may be provided, and more than one interface 1202 may be provided.

For a case where the chip is configured to implement functions of the network device in embodiments of the present disclosure (such as the first node device, the second node device, the core network device and/or the third node device in the aforementioned method embodiment):
the processor 1201 is configured to implement various steps in FIGS. 2 to 9 above.

In an embodiment of the present disclosure, the chip further includes a memory 1203, and the memory 1203 is configured to store necessary computer programs and data.

Those skilled in the art can also understand that the various illustrative logical blocks and steps listed in the embodiments of the present disclosure can be implemented by electronic hardware, computer software, or a combination of both. Whether such functionality is implemented in hardware or software depends on the specific application and overall system design requirements. Those skilled in the art can use various methods to implement the described functions for each specific application, but such implementation should not be understood as exceeding the scope of protection of the embodiments of the present disclosure.

Embodiments of the present disclosure further provide a communication system. The system includes the communication device as the terminal device in the above embodiments and the communication device as the network device (such as the first node device, the second node device, the core network device and/or the third node device in the aforementioned method embodiments), or the system includes the communication device as the terminal device as the terminal device and the communication device as the network device (such as the first node device, the second node device, the core network device and/or the third node device in the aforementioned method embodiments) in the above embodiments of FIG. 11.

The present disclosure further provides a readable storage medium on which instructions are stored. When the instructions are performed by a computer, the functions of any of the above method embodiments are implemented.

The present disclosure further provides a computer program product, which, when been performed by a computer, implements the functions of any of the above method embodiments.

In the above embodiments, it may be implemented in whole or in part by software, hardware, firmware, or any combination thereof. When implemented by software, it may be implemented in whole or in part in the form of a computer program product. The computer program product includes one or more computer programs. When the computer program is loaded and executed on a computer, the processes or functions described in accordance with the embodiments of the present disclosure are generated in whole or in part. The computer may be a general-purpose computer, a dedicated computer, a computer network, or other programmable device. The computer program may be stored in a computer-readable storage medium, or been transferred from one computer-readable storage medium to another, for example, the computer program may be transferred from a website, computer, server, or data center to another website, computer, server or data center via wired (such as coaxial cable, optical fiber, digital subscriber line (DSL)) or wireless (such as infrared, wireless, microwave, or the like) means. The computer-readable storage medium may be any available medium that can be accessed by a computer, or a data storage device such as an integrated server, data center, or the like, that includes one or more available media. The available media may be magnetic media (e.g., floppy disks, hard disks, magnetic tapes), optical media (e.g., high-density digital video discs (DVD)), or semiconductor media (e.g., solid state disks, SSD)) or the like.

Those of ordinary skill in the art can understand that the first, second, and other numerical numbers involved in the present disclosure are only distinctions made for convenience of description and are not used to limit the scope of the embodiments of the disclosure, nor to indicate the order. At least one in the present disclosure can also be described as one or more, and the plurality can be two, three, four or more, which is not limited in the present disclosure. In an embodiment of the present disclosure, for one type of technical feature, “first”, “second”, “third”, “A”, “B”, “C” and “D”, or the like are used to distinguish the technical features in the type of technical feature, and the technical features described with “first”, “second”, “third”, “A”, “B”, “C” and “D” are in no order of precedence or order of size.

The correspondence shown in each table in the present disclosure may be configured or predefined. The values of information in each table are just examples, and may be configured as other values, which are not limited in the present disclosure. When configuring a correspondence between the information and various parameters, it is not necessary to configure all the correspondences shown in the tables. For example, the correspondences shown in some rows of the tables in the present disclosure may not be configured. For another example, appropriate deformations or adjustments (such as splitting, merging, and so on) can be made based on the above table. The names of parameters shown in the titles of the above tables may also adopt other names understandable by the communication device, and the values or representations of the parameters may also be other values or representations understandable by the communication device. When the above tables are implemented, other data structures may also be used, for example, arrays, queues, containers, stacks, linear tables, pointers, linked lists, trees, graphs, structural body, classes, heaps, or hash tables may be used.

The term “predefinition” in the present disclosure may be understood as definition, pre-definition, storage, pre-storage, pre-negotiation, pre-configuration, curing, or pre-firing.

Those of ordinary skill in the art can appreciate that the units and algorithm steps of various examples described in conjunction with embodiments disclosed herein may be implemented by the electronic hardware, or a combination of the computer software and the electronic hardware. Whether these functions are executed by the hardware or the software depends on the specific applications and design constraints of the technical solution. For each particular application, those skilled in the art may use different methods to implement the described functions, but such implementation should not be considered beyond the scope of the present disclosure.

Those skilled in the art can clearly understand that for the convenience and brevity of the description, the specific working process of the above-described system, device and unit may refer to the corresponding process in the foregoing method embodiments, which will not be repeated here.

The above only describes some specific implementations of the present disclosure, but the protection scope of the present disclosure is not limited thereto. Any changes or substitutions that are conceivable to those skilled in the art within the technical scope of the present disclosure should fall within the protection scope of the present disclosure. Therefore, the protection scope of the present disclosure should be determined by the protection scope of the claims.

1. A method for transmission configuration, executed by a first node device, and comprising:
sending flow split related configuration information to a second node device, wherein the flow split related configuration information is used by the second node device to process data of a service.

2. The method according to claim 1, further comprising:
sending a first message to the second node device, wherein the first message comprises the flow split related configuration information;
wherein, in a case where the first node device is a next generation NodeB Central Unit (qNB-CU) or a gNB Central Unit Control Plane (qNB-CU-CP), and the second node device is a gNB Distributed Unit (gNB-DU), the first message comprises at least one of:
a UE context setup request message;
a UE context modification request message; or
a F1 application protocol message;
in a case where the first node device is the gNB-CU or the gNB-CU-CP, and the second node device is a gNB Central Unit User Plane (gNB-CU-UP), the first message comprises at least one of:
a bearer context setup request message;
a bearer context modification request message; or
an E1 application protocol message;
in a case where the first node device is a Master Node (MN), and the second node device is a Secondary Node (SN), the first message comprises at least one of:
a Secondary Node (SN) addition request message;
a SN modification request message; or
an Xn application protocol message.

3. The method according to claim 1, wherein the flow split related configuration information comprises at least one of:
flow split indication information, wherein the flow split indication information is configured to indicate the second node device to establish at least two entities;
flow split quantity information, wherein the flow split quantity information is configured to indicate the second node device to establish entities whose quantity is a flow split quantity indicated by the flow split quantity information;
mapping relationship information, wherein the mapping relationship information is configured to indicate a mapping relationship between a data packet and an entity to which the data packet is to be flow split; or
flow split type information, wherein the flow split type information is configured to indicate the second node device to perform, on at least one of uplink data or downlink data related to the flow split type information, processing related to the flow split type information.

4. The method according to claim 3, wherein the entity comprises at least one of:
a Radio Link Control (RLC) entity;
a Packet Data Convergence Protocol (PDCP) entity; or
a Media Access Control (MAC) entity.

5. The method according to claim 1, further comprising:
determining the flow split related configuration information according to service related information,
wherein determining the flow split related configuration information according to the service related information comprises:
receiving the service related information sent by a third node device; and
determining the flow split related configuration information according to the service related information.

6. (canceled)

7. The method according to claim 5, wherein receiving the service related information sent by the third node device comprises at least one of:
receiving, through a control plane, the service related information sent by the third node device; or
receiving, through a user plane, the service related information sent by the third node device.

8. The method according to claim 5, further comprising:
receiving a second message sent by the third node device, wherein the second message comprises the service related information;
wherein in response to the service related information being received through a control plane:
in a case where the first node device is a base station, and the third node device is a core network device, the second message comprises at least one of:
a UE context setup message;
a Protocol Data Unit (PDU) session resource setup request message;
a PDU session resource modification request message;
a handover request message; or
a NG Application Protocol (NGAP) message;
in a case where the first node device is a source base station in a handover process, and the third node device is a destination base station in the handover process, the second message comprises at least one of:
the handover request message; or
an Xn application protocol message;
in a case where the first node device is a Master Node (MN) in a Dual-connectivity (DC) scenario, and the third node device is a Secondary Node (SN) in the DC scenario, the second message comprises at least one of:
a SN addition request message;
a SN modification request message; or
the Xn application protocol message;
in a case where the first node device is a serving base station of a User Equipment (UE), and the third node device is an anchor base station or a last serving base station of the UE, the second message comprises at least one of:
a retrieve UE context feedback message; or
the Xn application protocol message;
in response to the service related information being received through a user plane, the second message comprises at least one of:
a bearer context modification request message; or
an E1 application protocol message.

9. The method according to claim 5, wherein the service related information comprises at least one of:
Protocol Data Unit (PDU) set indication;
sub-Quality of Service (sub-QoS) flow indication;
service type indication; or
data type indication.

10. The method according to claim 1, wherein the service comprises at least one of:
an Extended Reality (XR) service;
a Virtual Reality (VR) service; or
a Cloud Gaming (CG) service.

11. A method for transmission configuration, executed by a second node device, and comprising:
receiving flow split related configuration information sent by a first node device; and
performing flow split processing on data of a service according to the flow split related configuration information.

12. The method according to claim 11, further comprising:
receiving a first message sent by the first node device, wherein the first message comprises the flow split related configuration information;
wherein, in a case where the first node device is a next generation NodeB Central Unit (gNB-CU) or a gNB Central Unit Control Plane (gNB-CU-CP), and the second node device is a gNB Distributed Unit (gNB-DU), the first message comprises at least one of:
a UE context setup request message;
a UE context modification request message; or
a F1 application protocol message;
in a case where the first node device is the gNB-CU or the gNB-CU-CP, and the second node device is a gNB-CU-UP, the first message comprises at least one of:
a bearer context setup request message;
a bearer context modification request message; or
an E1 application protocol message;
in a case where the first node device is a Master Node (MN), and the second node device is a Secondary Node (SN), the first message comprises at least one of:
a Secondary Node (SN) addition request message;
a SN modification request message; or
an Xn application protocol message.

13. (canceled)

14. (canceled)

15. The method according to claim 11, wherein the flow split related configuration information is determined by service related information.

16. (canceled)

17. (canceled)

18. A method for transmission configuration, executed by a third node device, and comprising:
determining service related information, wherein the service related information is used by a first node device to determine flow split related configuration information, and the flow split related configuration information is used by a second node device to perform flow split processing on data of a service.

19. The method according to claim 18, further comprising:
sending the service related information to the first node device,
wherein sending the service related information to the first node device comprises at least one of:
sending the service related information to the first node device through a control plane; or
sending the service related information to the first node device through a user plane.

20. (canceled)

21. The method according to claim 18, further comprising:
sending a second message to the first node device, wherein the second message comprises the service related information;
wherein, in response to the service related information being sent through a control plane:
in a case where the first node device is a base station, and the third node device is a core network device, the second message comprises at least one of:
a UE context setup message;
a Protocol Data Unit (PDU) session resource setup request message;
a PDU session resource modification request message;
a handover request message; or
a NG Application Protocol (NGAP) message;
in a case where the first node device is a source base station in a handover process, and the third node device is a destination base station in the handover process, the second message comprises at least one of:
the handover request message; or
an Xn application protocol message;
in a case where the first node device is a Master Node (MN) in a Dual-connectivity (DC) scenario, and the third node device is a Secondary Node (SN) in the DC scenario, the second message comprises at least one of:
a SN addition request message;
a SN modification request message; or
the Xn application protocol message;
in a case where the first node device is a serving base station of a User Equipment (UE), and the third node device is an anchor base station or a last serving base station of the UE, the second message comprises at least one of:
a retrieve UE context feedback message; or
the Xn application protocol message;
in response to the service related information being sent through a user plane, the second message comprises at least one of:
a bearer context modification request message; or
an E1 application protocol message.

22. (canceled)

23. (canceled)

24. A communication device, comprising:
a processor; and
a memory storing a computer program executable by the processor,
wherein the processor is configured to perform the method according to claim 1.

25. A communication device, comprising:
a processor; and
a memory storing a computer program executable by the processor,
wherein the processor is configured to perform the method according to claim 11.

26. A communication device, comprising:
a processor; and
a memory storing a computer program executable by the processor,
wherein the processor is configured to perform the method according to claim 18.

27. A communication system, comprising:
a first node device, a second node device, and a third node device, wherein the first node device executes the method according to claim 1.

28. A non-transitory computer-readable storage medium storing instructions that, when executed by a processor, cause the processor to perform the method according to claim 1.
